(19) United States
(12) Patent Application Publication
(10) Pub. No.: US 2019/0059566 A1
(43) Pub. Date: Feb. 28, 2019

(54) Pacifier Support

(71) Applicant: Halina Gaudyn, Park Ridge, IL (US)

(72) Inventor: Halina Gaudyn, Park Ridge, IL (US)

(21) Appl. No.: 15/687,134

(22) Filed: Aug. 25, 2017

(51) Int. Cl. A45F 5/02; A41B 13/10; A61J 17/00

(52) U.S. Cl. CPC A45F 5/02; A61J 17/001; A41B 13/10

(57) ABSTRACT

An apparatus composed of a child's garment having an attachment point and an appliqué, the appliqué having an attachment point and a ribbon, the appliqué attachment point matable to the attachment point on the child's garment. The apparatus can have the attachment points on the garment and appliqué being matable hook and loop fasteners. The apparatus may also have a toy and in cases that toy is a pacifier.

This application claims the benefit of application Ser. No. 15/330,143 filed 15 Aug., 2016.

### FIELD OF THE INVENTION

The present invention generally relates to child wear, in particular, apparatuses for aiding in retaining child accessories to clothing and other fabrics.

### BACKGROUND

Babies, in particular children under the age of two, are often fussy or noncompliant when traveling. Indeed, this problem can even persist in the home: they cry, teeth, spit, throw, etc. As such, many tools have been developed to help sooth babies, such as a pacifier or teething ring.

According to The American Academy of Pediatrics (AAP) The benefits of pacifier use include analgesic effects, shorter hospital stays for preterm infants, and a reduction in the risk of sudden infant death syndrome. Pacifiers have been studied and recommended for pain relief in newborns and infants undergoing common, minor procedures in the emergency department. The AAP recommends that parents consider offering pacifiers to infants one month and older at the onset of sleep to reduce the risk of sudden infant death syndrome. Pacifier use should not be actively discouraged and may be especially beneficial in the first six months of life, but presents risk afterwards. Previous devices have attempted to solve this problem with varying degrees of success, however none have fully addressed the issues. Examples follow.

U.S. Pat. No. 5,954,749 by Fields discloses a mesh pacifier and associated clip attachment including a shield comprised of a peripheral rim dimensioned for surrounding a mouth of a baby. A nipple portion extends forwardly from the shield. A handle portion extends rearwardly from the shield. A plurality of sections of apertures are formed through the shield.

U.S. Pat. No. 8,196,221 by Fuwausa et al, discloses a wearable garment with a stitched or otherwise secured accessory, which is preferably a one piece PVC or injection molded plastic accessory. The accessory includes a base for attachment to the garment and a disk in the general shape of a bottle cap and bottle flange. The disk is attached together with the base by a flexible tether. The base unit is glued, stitched or otherwise attached to the wearable garment and the, bottle cap shape, is snapped onto the base unit.

US Patent Application No 2009/0199325 by Fuwasa et al discloses another wearable garment with a stitched or otherwise secured accessory, which is preferably a one piece PVC or injection moulded plastic accessory. The accessory includes a base for attachment to the garment and a disk in the general shape of a bottle cap and bottle flange. The disk is attached together with the base by a flexible tether. The base unit is glued, stitched or otherwise attached to the wearable garment and the, bottle cap shape, is snapped onto the base unit.

US Patent Application No 2013/0247277 by Turbovich discloses a method is provided for designing a garment having a plurality of surfaces. The method includes selecting at least one surface from the plurality of surfaces to serve as a tactile stimulating surface. The method further includes selecting a texture for the at least one surface, different from that of at least a majority of the plurality of surfaces, configured to provide tactile stimulation to a touch sensing organ.

US Patent Application No 2016/0213136 by Roehrig discloses a pacifier strap (1) for connecting a pacifier (2) to a fastening clip (3), said pacifier strap (1) forming a loop (4) at at least one end and having adjustment means (5) for adjusting the length of the loop (4), so that the longitudinal extension of the pacifier strap (1) can be adjusted between a maximum length of the loop (4) and a minimum length of the loop (4), and having a container (7) for receiving at least one nipple (8) of the pacifier (2), which container (7) can be connected, at least temporarily, to the adjustment means (5).

These tools, present a separate problem: they end up on the floor due to the fickle nature of children accumulating dust, dirt, germs, and other contaminants. Thus, there is a need for a device to ensure such items designed to go into a child's mouth remain off the floor.

These problems, and others, are addressed by the present invention and discussed in greater detail below.

### BRIEF SUMMARY

Currently-available devices lack many of the proposed features described below. The pacifier support and holder of the present disclosure allows parents to provide children with a toy, pacifier, bottle or other device that will stay in place even as a child moves during the day, thereby reducing the risk of contamination and loss.

The current design uses a hook-and-loop (velcro) applique and attachment design. This offers a way to attach tools and toys such as pacifiers and teething rings to a baby's clothing in a way that won't potentially damage the clothing. By having the toys attached to their clothing, babies won't lose necessary items like pacifiers when they occasionally spit or throw them. Instead of falling to the floor, the toy with hang off the baby's clothing and remain within reach of the child. Other clothing and pacifier options have not offered such changes to the baby's experience.

The advantages of such an application become clear when one is experienced in caring for infants, sanitation, toymaking, and other related fields. Typical devices currently on the market do not have the confluence and plethora of features contemplated and described herein.

In a first embodiment 1 the disclosure contemplates an apparatus having a child's garment having an attachment point, and an appliqué, the appliqué having an attachment point and a ribbon, the appliqué attachment point matable to the attachment point on the child's garment. In certain cases the attachment points on the garment and applique are matable hook and loop fasteners. It may be preferred to have the attachment points when mated form a smiley face. Sometimes the appliqué attachment point is a flower shape with the hook and loop fasteners are only on the pistil portion of the flower and the petals are free to flap. In some cases this is composed of a child's toy, the toy being attached to the ribbon by tying. In some cases the toy is a pacifier. In some embodiments the attachment points on the garment and appliqué are matable snap on fasteners. In some embodiments the attachment points when mated form a smiley face, the snap on fasteners being the two eyes of the smiley face. Sometimes the apparatus involves a child's toy, the toy being attached to the ribbon by tying.

In another embodiment the disclosure contemplates an appliqué the appliqué having an attachment point and a ribbon. The attachment point may be hook and loop fastener. The attachment point may form a smiley face. The appliqué attachment point may be a flower shape with the hook and loop fasteners are only on the pistil portion of the flower and the petals do not have hook and loop fasteners. A child's toy may be attached, the toy being attached to the ribbon by tying. The toy may be a pacifier. The attachment points on the garment and appliqué may be matable snap on fasteners.

In another embodiment the disclosure contemplates a method of using appliqués to attach babies toys to clothing the method having the steps of providing a child's garment having an attachment point, providing an appliqué, the appliqué having an attachment point and a ribbon, the appliqué attachment point matable to the attachment point on the child's garment, providing a child's toy, attaching the toy to the ribbon, and attaching the appliqué to the clothing at the attachment point. The attachment points on the garment and appliqué may be matable hook and loop fasteners. The toy may preferably be a pacifier.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1. is a front view of a garment and pacifier apparatus according to the present disclosure.

FIG. 2 is a perspective view of an embodiment of a garment and pacifier apparatus using hook-and-loop fasteners according to the present disclosure.

FIG. 3 is a perspective view of an embodiment of a garment and pacifier apparatus using snap on fasteners according to the present disclosure.

FIG. 4 is a front view of a ribbon and hook-and-loop connector according to the present disclosure.

FIG. 5a is a front view of another embodiment ribbon and hook-and-loop connector according to the present disclosure.

FIG. 5b is a top view of the connection portion of the ribbon and hook-and-loop connector of FIG. 5a.

### DETAILED DESCRIPTION

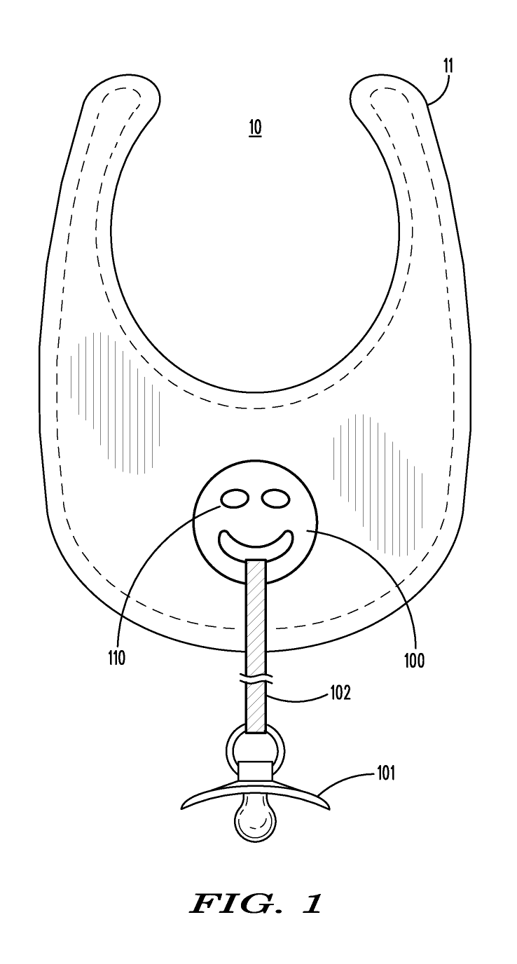

Referring now the drawings with more specificity, the present invention essentially discloses an apparatus for preventing the dropping of a child's pacifier or other toys. The preferred embodiments of the present invention will now be described with reference to FIGS. 1-5 of the drawings. Variations and embodiments contained herein will become apparent in light of the following descriptions.

The apparatus 10, of the current disclosure is primarily composed of a garment 11 and an attachment 100. The attachment 100 provides a way to attach toys 101 such as pacifiers and teething rings to a garment 11. By having toy 101 attached to clothing 11 in this way, toys 101 wont be lost, and instead will hang via ribbon 102 from the garment 11. An advantage of the present invention is that attachment point 110 is detachable from the garment 11 and thus if pulled vigorously by the child will pull away, instead of tearing the fabric. according to this disclosure.

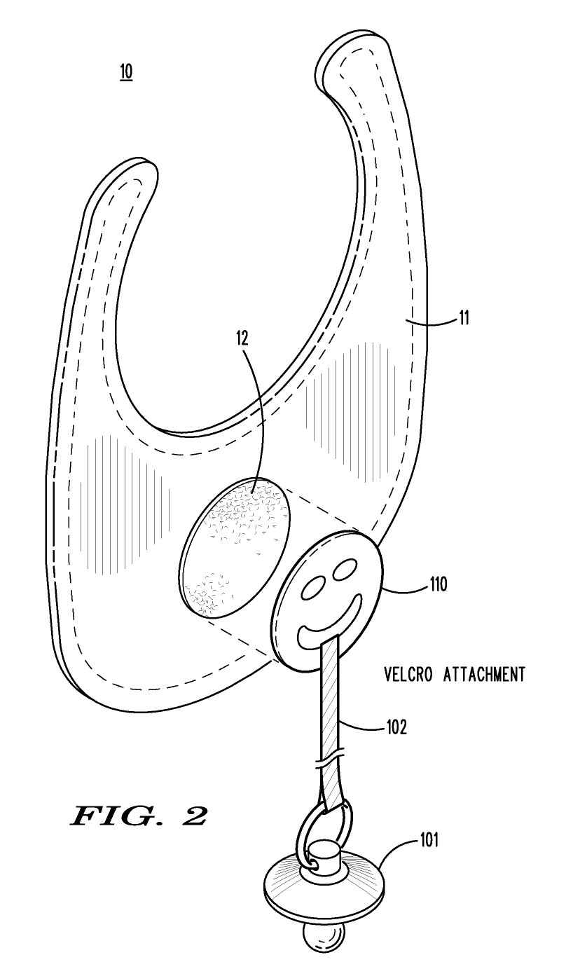

As seen in FIG. 2, the velcro applique and attachment 110 are composed of a small bit of Velcro (hook and loop fasteners) 12 that is sewn onto a child's garment 11 with a matching strip 110 attached to a ribbon 102 that can be looped around toys 101 such as pacifiers and teething rings. The hook and loop fastener 12 to be part of the larger garment 11. For example the attachment in FIG. 2 is a smiling face 110. When placed onto the garment 11, the cut outs in applique 110 make the smiley face more clear. Many designs can for attachment point 110 are contemplated such as animals, cartoons, etc.

The reason for using hook and loop fasteners is that this will prevent damage to the clothing 11 if the child decides to vigorously pull at the attachment or toy 101. When a child pulls a clip attached to his or her clothing, this can damage the garment or even injure the child. Soft attachments 110 as disclosed herein comes apart without damaging the clothing, and it offers additional design elements for baby clothing.

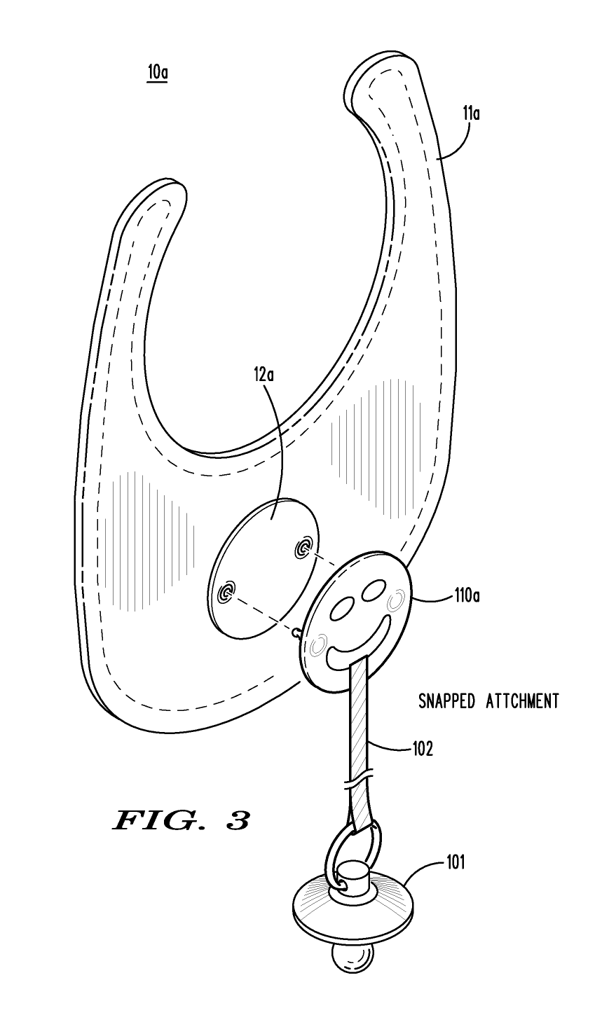

Looking to FIG. 3, another embodiment 10a for attaching the toy 101 to a garment 11a. In this embodiment, hook and loop fasteners 12 are replaced by snap attachments 12a and 110a. The snap-on attachment provides advantages over the hook and loop implementation in certain situations, such as resiliency against spills (which can often decrease the adhesion of hook and loop fasteners). However, there are other trade offs when using snap on attachments 12a compared to the soft attachments 12, such as hard points that may attached the baby.

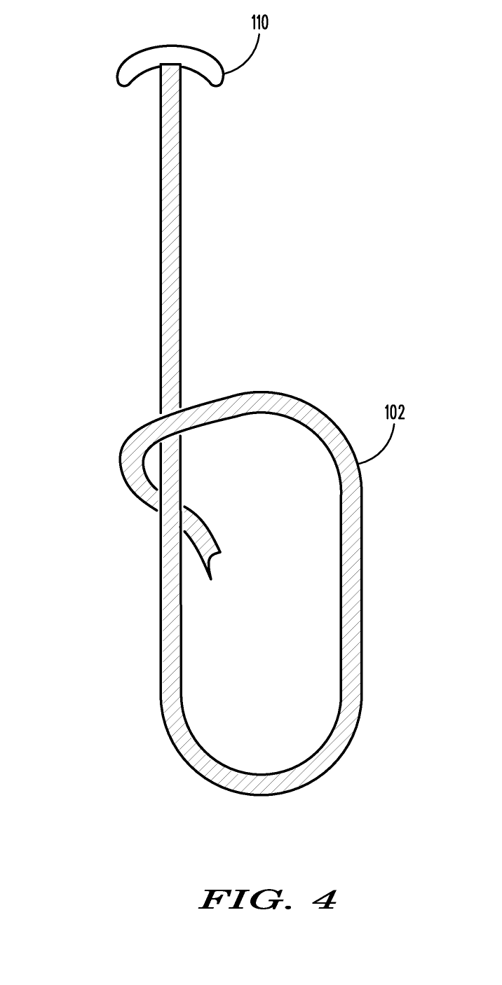

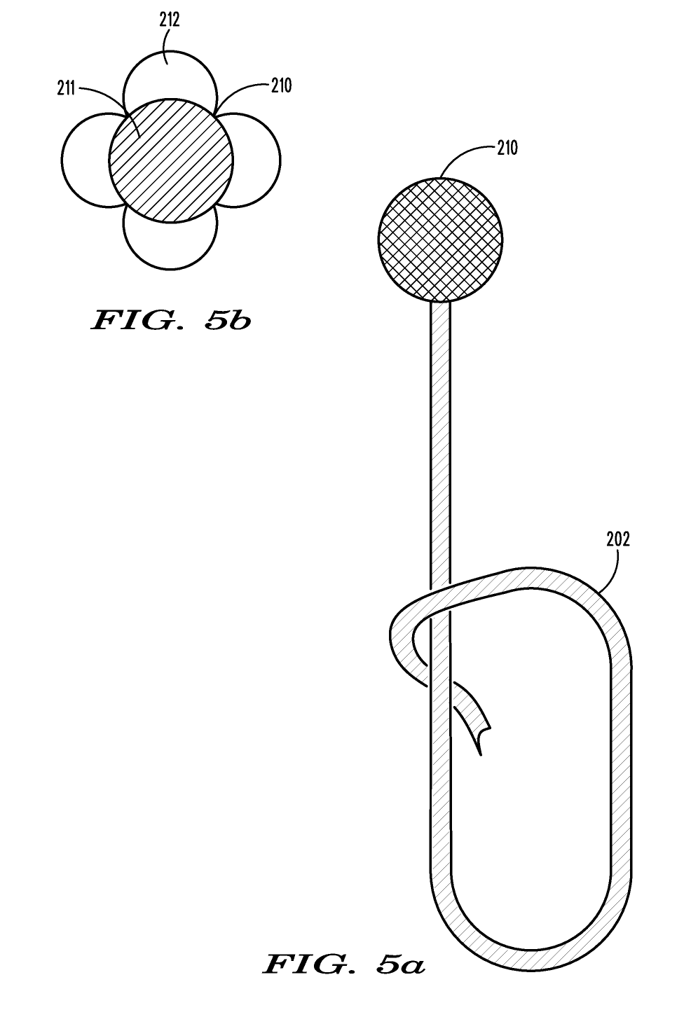

Similarly, Ribbon 102 and attachment 110 is shown in detail in FIG. 4. As can be seen, the ribbon 102 can be tied in various ways to hold many different toys such as pacifiers. This is, in many ways, superior to directly connecting the ribbon to a single toy. This aids in washing. Another embodiment is shown in FIG. 5. In this embodiment ribbon 202 is connected to a flower shaped attachment 210. This attachment utilizes hook and loop fasteners at the flower's central portion of the flower (pistil) 211 while the petals 212 are allowed to freely flap.

### INDUSTRIAL APPLICABILITY

The prosthetic apparatus 10 is constructed by taking a child's garment 11 and cutting out an appropriate amount of hook and loop fastener 12 then attaching that to the desired part of the garment 11. A matching shape is cut and sewn to the attachment portion of toy holder 100. This is attached to a ribbon 102. Later, a user may use the ribbon 102 to hold a toy 101 by tying the ribbon 102 around a toy.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

1. An apparatus comprising:
a child's garment having an attachment point; and
an appliqué, the appliqué having an attachment point and a ribbon the ribbon being attached to the appliqué attachment point, the appliqué attachment point matable to the attachment point on the child's garment;
the appliqué having an ornamental design, and
wherein the garment, ribbon, and appliqué are washable.

2. The apparatus of claim 1 wherein the attachment points on the garment and appliqué are matable hook and loop fasteners.

3. The apparatus of claim 2 wherein the attachment points when mated form a smiley face.

4. The apparatus of claim 2 wherein the appliqué attachment point is a flower shape with the hook and loop fasteners are only on the pistil portion of the flower and the petals are free to flap.

5. The apparatus of claim 2 further comprising a child's toy, the toy being attached to the ribbon by tying.

6. The apparatus of claim 5 wherein the toy is a pacifier.

7. The apparatus of claim 1 wherein the attachment points on the garment and appliqué are matable snap on fasteners.

8. The apparatus of claim 7 wherein the attachment points when mated form a smiley face, the snap on fasteners being the two eyes of the smiley face.

9. The apparatus of claim 7 further comprising a child's toy, the toy being attached to the ribbon by tying.

10. An appliqué the appliqué having an attachment point and a ribbon wherein the attachment point is a hook and loop fastener, a child's toy, the toy being removably attached to the ribbon, the ribbon being washable.

11. (canceled)

12. The apparatus of claim 11 wherein the attachment point forms a smiley face.

13. The apparatus of claim 12 wherein the appliqué attachment point is a flower shape with the hook and loop fasteners are only on the pistil portion of the flower and the petals do not have hook and loop fasteners, wherein the petals are free and movable when the attachment point is attached.

14. The apparatus of claim 11 further comprising a child's toy, the toy being attached to the ribbon by tying.

15. The apparatus of claim 10 wherein the toy is a pacifier.

16. The apparatus of claim 10 wherein the attachment points on the appliqué are matable snap on fasteners, the snap on fasteners being the two eyes of a smiley face.

17. (canceled)

18. (canceled)

19. (canceled)

20. An apparatus comprising:
a child's garment having an attachment point; and
an appliqué, the appliqué having an attachment point and a ribbon, the appliqué attachment point matable to the attachment point on the child's garment;
wherein the attachment points on the garment and appliqué are matable snap on fasteners; and
wherein the attachment points when mated form a smiley face, the snap on fasteners being the two eyes of the smiley face.
